(19) United States
(12) Patent Application Publication
(10) Pub. No.: US 2016/0274446 A1
(43) Pub. Date: Sep. 22, 2016

(54) LIGHT SOURCE APPARATUS AND PROJECTION DISPLAY APPARATUS

(71) Applicant: Panasonic Intellectual Property Management Co., Ltd., Osaka (JP)

(72) Inventor: TAKAAKI TANAKA, Osaka (JP)

(21) Appl. No.: 15/058,209

(22) Filed: Mar. 2, 2016

(30) Foreign Application Priority Data
Mar. 19, 2015 (JP) 2015-056725
Feb. 18, 2016 (JP) 2016-028454

(51) Int. Cl. G03B 21/20; H04N 9/31; F21V 14/08; G03B 21/00; F21V 13/14; F21V 9/16

(52) U.S. Cl. CPC G03B 21/204; F21V 13/14; F21V 9/16; F21V 14/08; G03B 21/008; H04N 9/3102; H04N 9/317; H04N 9/3152

(57) ABSTRACT

A light source apparatus of the disclosure includes a solid state light source; a substrate that has a phosphor region where a phosphor is formed that emits fluorescent light produced by exciting light supplied from the solid state light source and a color filter region where a color filter is formed inside the phosphor region; and an optical means that leads light from the phosphor region so as to be discharged to a first direction (i.e., a direction in which the exciting light enters) and so as to enter the color filter region from a second direction that is opposite to the first direction.

### BACKGROUND

1. Technical Field

The present disclosure relates to a projection display apparatus that irradiates an image formed over a small light bulb with illumination light and enlarge-projects the image onto a screen through a projection lens, and to a light source apparatus used for the projection display apparatus.

2. Description of the Related Art

As a light source of a projection display apparatus using digital micromirror device (DMD) of a mirror-deflecting or a light bulb for a liquid crystal display panel, a discharge lamp is commonly used. A discharge lamp undesirably has a short service life and low reliability. Thus in recent years, a projection display apparatus has been developed that uses a solid state light source (e.g., semiconductor laser, LED) with a long service life.

Patent literature 1 discloses a light source apparatus that is compact and efficiently condenses light from a solid state light source. With the light source apparatus described in the document, light from the solid state light source enters the fluorescent substrate, the light excite-emitted by the phosphor is condensed through a lens and is reflected by a mirror, and then the light is condensed to a color wheel substrate by a lens. The light condensed changes its color to a desired one by the color filter of the color wheel substrate and enters the rod. The two substrates (the fluorescent substrate and the color wheel substrate) are rotationally controlled by a motor having a rotation axis same as that of the substrates.

### CITATION LIST

### Patent Literature

PTL 1: WO 2012/075947

### SUMMARY

The disclosure provides a compact, highly efficient light source apparatus that avoids a decrease in fluorescence efficiency and upsizing of the optical system when the power of exciting light has increased, and a compact projection display apparatus using the light source apparatus.

A light source apparatus of the disclosure includes a solid state light source; a substrate that has a phosphor region where a phosphor is formed that emits fluorescent light produced by exciting light supplied from the solid state light source and a color filter region where a color filter is formed inside the phosphor region; and an optical means that leads light from the phosphor region so as to be discharged to a first direction (i.e., a direction in which the exciting light enters) and so as to enter the color filter region from a second direction that is opposite to the first direction.

Another light source apparatus of the disclosure includes a solid state light source; a fluorescent substrate that emits fluorescent light by exciting light from the solid state light source; a color filter substrate on which a color filter is formed; and an optical means that leads light discharged from the fluorescent substrate to a first direction (i.e., a direction in which the exciting light enters) and to enter the color filter substrate from a second direction that is opposite to the first direction. The fluorescent substrate and the color filter substrate are disposed alongside of each other on the same rotary drive axis. The color filter is formed with a diameter smaller than that of the fluorescent substrate.

The disclosure provides a small, highly efficient light source apparatus that avoids a decrease in fluorescence efficiency and upsizing of the optical system when the power of exciting light has increased, and a compact projection display apparatus using the light source apparatus.

### BRIEF DESCRIPTION OF DRAWINGS

FIG. 1 is a block diagram of a light source apparatus according to the first exemplary embodiment.

FIGS. 2A through 2C illustrate the configuration of a substrate according to the first embodiment.

FIG. 3 is a block diagram of a light source apparatus according to the second exemplary embodiment.

FIGS. 4A through 4C illustrate the configuration of a substrate unit according to the second embodiment.

FIG. 5 is a block diagram of a light source apparatus according to the third exemplary embodiment.

FIG. 6 is a block diagram of a projection display apparatus according to the fourth embodiment.

### DESCRIPTION OF EMBODIMENTS

Hereinafter, a detailed description is made of some exemplary embodiments with reference to the related drawings as appropriate. However, a detailed description more than necessary may be omitted, such as a description of a well-known item and a duplicate description for a substantially identical component, to avoid an unnecessarily redundant description and to allow those skilled in the art to easily understand the following description.

Note that the accompanying drawings and the following description are provided for those skilled in the art to well understand the disclosure and are not intended to limit the subjects described in the claims.

### First Exemplary Embodiment

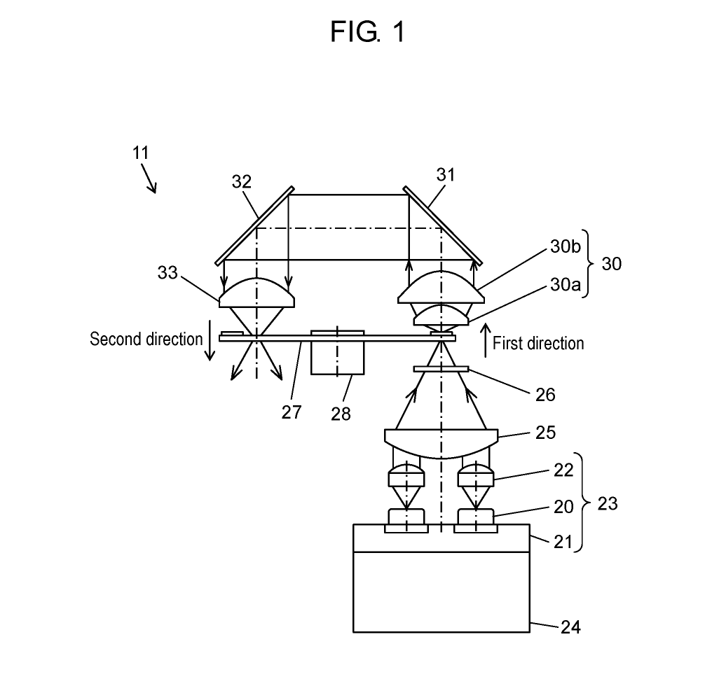

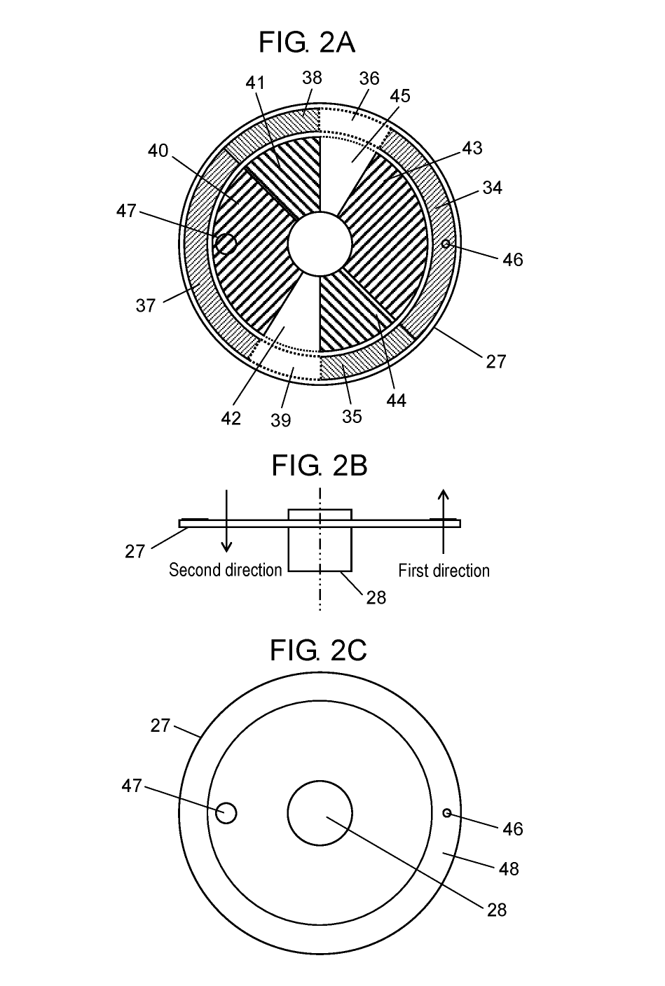

Hereinafter, a description is made of the first exemplary embodiment using FIGS. 1 and 2A through 2C. FIG. 1 is a block diagram of a light source apparatus according to the first embodiment.

Light source apparatus 11 includes solid state light source unit 23 that has semiconductor laser 20 as a solid state light source, radiator plate 21, and collimate lens 22. Light source apparatus 11 further includes heat sink 24, lens 25, diffusion plate 26, substrate 27 on which a phosphor and a color filter are formed, motor 28, first condenser lens 30 composed of one set of lenses 30a and 30b, mirrors 31 and 32, and second condenser lens 33. Here, motor 28 is an example of a rotating body.

Solid state light source unit 23 is formed of 8 (2×4) pieces of semiconductor lasers 20 and collimate lenses 22 in a square matrix two-dimensionally at constant intervals on radiator plate 21. Heat sink 24 cools solid state light source unit 23. Semiconductor laser 20 is a blue semiconductor laser that emits and discharges blue light with a wavelength width of 440 nm to 455 nm.

Each light beam discharged from multiple semiconductor lasers 20 is condensed through corresponding collimate lens 22 and is converted into a parallel light pencil. The group of the light pencils is condensed through convex lens 25 and enters diffusion plate 26. Diffusion plate 26, made of glass, diffuses light with microscopic asperities on its surface. The diffusion angle, a half-value angle width at which the intensity of diffusion light reaches 50% of the maximum, is as small as approximately 3 degrees. Assuming that a spot diameter is defined as a diameter at which the intensity of light reaches 13.5% of the peak intensity, the light discharged from diffusion plate 26 is superimposed to spotted light with a spot diameter of 1 mm to 2 mm and enters substrate 27. Diffusion plate 26 diffuses light so that the spotted light has a desired diameter.

Substrate 27 is a circular substrate rotationally controllable by motor 28 in its center. On substrate 27, a phosphor region and a color filter region are formed. Substrate 27 is a sapphire substrate with a high transmittance and a high heat conductivity, and at the same time rotating substrate 27 suppresses a temperature rise of the phosphor due to exciting light, thereby stably maintaining the efficiency of fluorescence conversion. FIG. 1 shows a first direction in which light from solid state light source unit 23 enters the phosphor region of substrate 27, and a second direction (opposite to the first direction) in which the light enters the color filter region.

FIGS. 2A through 2C illustrate substrate 27 on which a phosphor region and a color filter region are formed. FIG. 2A is a plan view of substrate 27 viewed in the second direction. FIG. 2B is a front view of substrate 27. FIG. 2C is a bottom view of substrate 27 viewed in the first direction.

Substrate 27 has a phosphor region and a diffusion region formed on the outer circumferential face (the outer circumferential ring-shaped zone) close to first condenser lens 30. In detail, as shown in FIG. 2A, the outer circumference of substrate 27 is divided into six segments, two of them (segments 34 and 37) are phosphor regions on which a green phosphor is applied, another two of them (segments 35 and 38) are phosphor regions on which a red phosphor is applied, and the remaining two of them (segments 36 and 39) are diffusion regions for blue light with microscopic asperities on their surfaces. Segments 34 and 37, segments 35 and 38, and segments 36 and 39 are formed on positions symmetric with respect to the rotation axis of substrate 27. The diffusion angle is approximately 10 degrees. As a green phosphor that emits fluorescent light containing a green component, Y₃Al₅O₁₂:Ce₃⁺ is used. As a red phosphor that emits fluorescent light containing a red component, CaAlSiN₃:Eu₂⁺ is used.

Substrate 27 has a color filter region where a color filter is formed, and an antireflection coat region where an antireflection coat is formed, both on the inner circumference of substrate 27. In detail, as shown in FIG. 2A, the inner circumferential region of substrate 27 is divided into six segments. Segments 40 and 43 have dichroic filters that transmit green light. Segments 41 and 44 have dichroic filters that transmit red light. Segments 42 and 45 have antireflection coats. The respective segments of the green-transmitting filter and the red-transmitting filter of the color filter region, and the antireflection coat are divided so as to correspond to the respective segments of the green phosphor and the red phosphor of the phosphor region, and the diffusion region. As a result, the green-transmitting filter, the red-transmitting filter, and the antireflection coat are respectively formed inside the green phosphor, the red phosphor, and the diffusion region As shown in FIG. 2C, substrate 27 has dichroic filter 48 formed on the face close to solid state light source unit 23. Dichroic filter 48 transmits blue light and reflects color light containing green and red components, and is formed in regions corresponding to segments 34 to 39 on the back face of the other face where the phosphor region and the diffusion region are formed. FIGS. 2A and 2C illustrate aspects of exciting light spot 46 that enters the phosphor region of substrate 27 and condensing spot 47 that enters the color filter region.

Back to FIG. 1, light diffused by diffusion plate 26 enters dichroic filter 48 formed on the outer circumference of substrate 27 from the first direction; is transmitted through blue-transmitting dichroic filter 48; and enters the phosphor region or the diffusion region formed on the surface of substrate 27. The light that has entered segments 34, 35, 37, and 38 of the phosphor region emits fluorescent color light containing green and red components and is discharged to the first direction. The light emitted toward blue-transmitting dichroic filter 48 is reflected by dichroic filter 48 and is discharged to the first direction. Blue light that has entered segments 36 and 39 as diffusion regions is diffused, and then is discharged to the first direction. The fluorescent light and the blue light discharged to the first direction are condensed through first condenser lens 30. First condenser lens 30 condenses light discharged from substrate 27 in a range of ±76 degrees and converts it to parallel light.

Light from first condenser lens 30 is reflected by mirrors 31 and 32, and its traveling direction is converted from the first direction to the second direction opposite to the first. Light from mirror 32 is condensed through second condenser lens 33 and enters the color filter region or the antireflection coat region formed on the inner circumference of substrate 27. The incident angle of the light is ±33 degrees and its spot diameter is approximately 2 mm to 4 mm.

The green light enters segments 40 and 43 of the color filter region; the red light enters segments 41 and 44 of the color filter region. The green light and red light that have entered the color filter region, with their unnecessary color components removed, become green light and red light with favorable color purity. Blue light that enters segments 42 and 45 as antireflection coat regions is transmitted. In this way, white light is discharged from substrate 27 to the second direction.

The substrate on which the phosphor and the color filter are formed, having one-piece structure, has a light weight and a favorable stability to keep rotation balance. The phosphor region positioned closer to the outer circumference than the color filter region allows light source apparatus 11 to be compact and high in the fluorescence conversion efficiency.

Substrate 27 may be a crystal substrate that has a heat conductivity lower than sapphire but is less expensive. Owing to an appropriate division ratio (division angle) of six segments 34, 35, 36, 37, 38, and 39 based on the value of efficiency in converting the wavelength from exciting light to each fluorescent light, the intensity ratio of green, red, and blue light can be adjusted, thereby providing white light with favorable white balance.

The outer circumference of the substrate may be divided into eight segments: red phosphors, green phosphors, Ce-activated YAG-based yellow phosphors, and diffusion regions. Then, the inner circumference of the substrate is divided into eight segments as well, and a color filter is formed that corresponds to yellow light fluorescence-emitted by the yellow phosphor in a region corresponding to the region where the yellow phosphor is formed.

Using a yellow phosphor allows providing bright white light with more favorable white balance.

In FIG. 1, one solid state light source unit is used; multiple solid state light source units may be used that are combined by mirrors.

As described above, light source apparatus 11 of this embodiment includes one substrate that has a phosphor region emitting fluorescent light by exciting light from a solid state light source and a color filter region where a color filter is formed, both on the outer and inner circumferences; and an optical system that leads light from the phosphor region so as to be discharged to the first direction (i.e., the direction in which the exciting light enters) and so as to enter the color filter region from the second direction that is opposite to the first direction, thereby providing a light source apparatus compact and high in the fluorescence conversion efficiency.

### Second Exemplary Embodiment

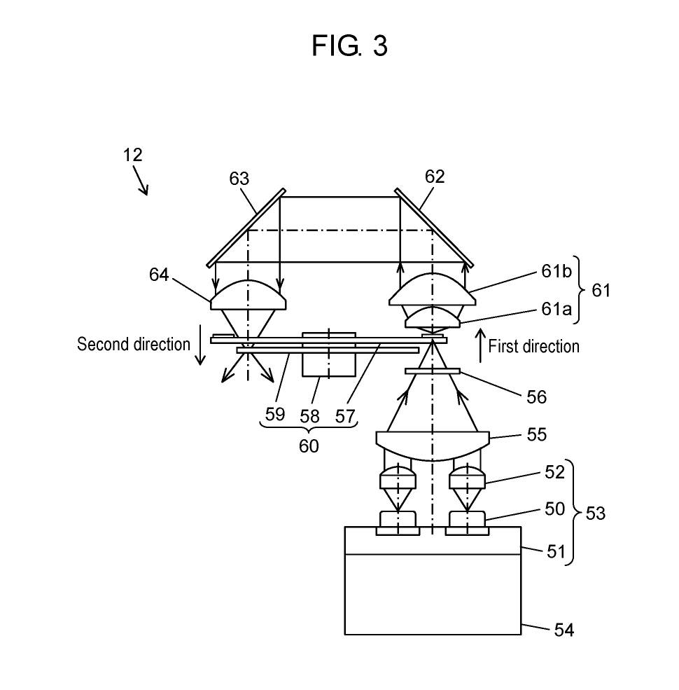

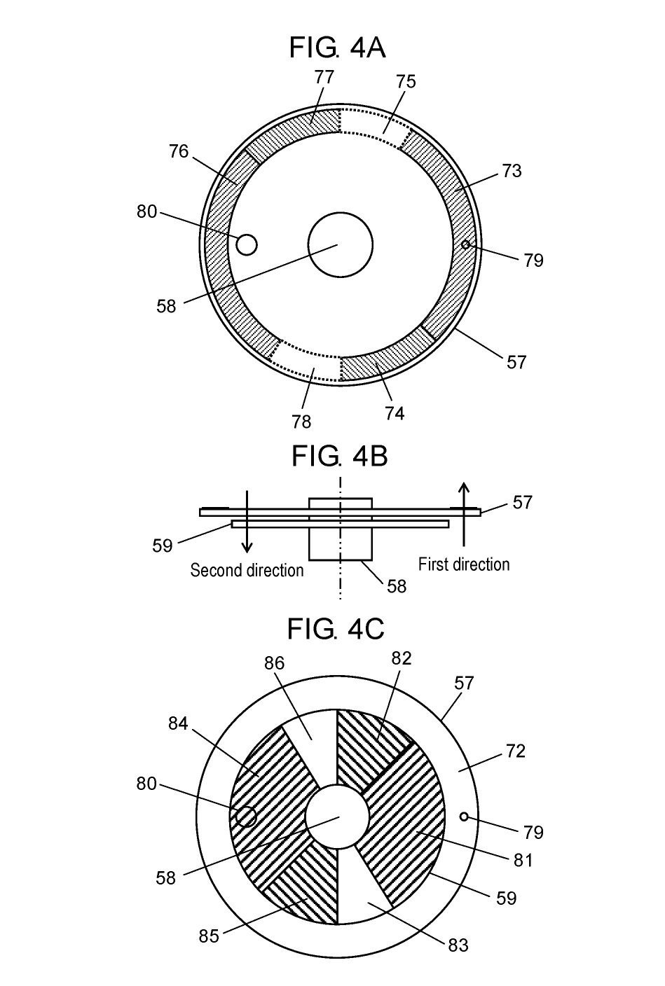

Hereinafter, a description is made of the second exemplary embodiment using FIGS. 3 and 4A through 4C. FIG. 3 is a block diagram of light source apparatus 12 according to the second embodiment.

Light source apparatus 12 has solid state light source unit 53 that includes semiconductor laser 50 as a solid state light source, radiator plate 51, and collimate lens 52. Light source apparatus 12 further includes heat sink 54; lens 55; substrate unit 60 composed of diffusion plate 56, fluorescent substrate 57, and motor 58; color filter substrate 59; first condenser lens 61 composed of one set of lenses 61a and 61b; mirrors 62 and 63; and second condenser lens 64. What is different from the first embodiment is that the two substrates: fluorescent substrate 57 and color filter substrate 59 are disposed alongside of each other in the direction of the rotary drive axis of one motor 58 and are mounted so as to be rotated simultaneously. The other point is that fluorescent substrate 57 is formed with an external diameter larger than that of color filter substrate 59. Here, motor 58 is an example of a rotating body.

Each light beam discharged from multiple semiconductor lasers 50 is condensed through corresponding collimate lens 52 and is converted into a parallel light pencil. The group of the light pencils is condensed through convex lens 55 and enters diffusion plate 56. Diffusion plate 56, made of glass, diffuses light with microscopic asperities on its surface. The diffusion angle, a half-value angle width at which the intensity of diffusion light reaches 50% of the maximum, is as small as approximately 3 degrees. Assuming that a spot diameter is defined as a diameter at which the intensity of light reaches 13.5% of the peak intensity, the light discharged from diffusion plate 56 is superimposed to spotted light with a spot diameter of 1 mm to 2 mm and enters fluorescent substrate 57. Diffusion plate 56 diffuses light so that the spotted light has a desired diameter.

Fluorescent substrate 57 and color filter substrate 59, which are circular substrates, are disposed on the same rotary drive axis of motor 58 and are rotationally drive-controlled by motor 58. Fluorescent substrate 57 is a sapphire substrate with a high transmittance and a high heat conductivity, and at the same time rotating substrate 27 suppresses a temperature rise of the phosphor due to exciting light, thereby stably maintaining the efficiency of fluorescence conversion. FIG. 3 shows the first direction in which light from solid state light source unit 53 enters the phosphor region formed on fluorescent substrate 57, and the second direction (opposite to the first direction) in which the light enters the color filter region formed on color filter substrate 59.

FIGS. 4A through 4C illustrate the structure of substrate unit 60. FIG. 4A is a plan view of substrate unit 60 viewed in the second direction. FIG. 4B is a front view of substrate unit 60. FIG. 2C is a bottom view of substrate unit 60 viewed in the first direction.

As shown in FIG. 4A, on the face of fluorescent substrate 57 close to first condenser lens 61, phosphor regions and diffusion regions for blue light are division-formed on a transparent sapphire glass substrate as six segments 73, 74, 75, 76, 77, and 78. The six segments are formed in the outer circumferential region of fluorescent substrate 57 outside the external diameter of color filter substrate 59. Two of them (segments 73 and 76) are phosphor regions on which a green phosphor is applied, segments 74 and 77 are phosphor regions on which a red phosphor is applied, and segments 75 and 78 are diffusion regions with microscopic asperities on their surfaces. Segments 73 and 76, segments 74 and 77, and segments 75 and 78 are formed on positions symmetric with respect to the rotation axis of motor 58.

On the face (the face close to solid state light source unit 53) opposite to the face on which the phosphor of fluorescent substrate 57 is formed, as shown in FIG. 4C, dichroic filter 72 that transmits blue light and reflects color light containing green and red is formed in the regions corresponding to segments 73 to 78. FIGS. 4A and 4C illustrate aspects of condensing spot 79 of exciting light that enters fluorescent substrate 57.

Color filter substrate 59 is divided into six segments 81, 82, 83, 84, 85, and 86 that are color filters. Segments 81 and 84 have dichroic filters transmitting green light; segments 82 and 85 have dichroic filters transmitting red light; and segments 83 and 86 have antireflection coats (blue-transmitting), each formed on a white glass plate. FIGS. 4A and 4C illustrate aspects of condensing spot 80 that enters fluorescent substrate 57 and color filter substrate 59. Segments 81 to 86 (green-transmitting, red-transmitting, and blue-transmitting) of the color filters are divided so as to respectively correspond to segments 73 to 78 of fluorescent substrates 57 for each color light. That is, segments 81 and 84 are positioned on the inner circumferences of segments 73 and 76; segments 82 and 85, on the inner circumferences of segments 74 and 77; and segments 83 and 86, on the inner circumferences of segments 75 and 78, respectively.

Back to FIG. 3, light diffused by diffusion plate 56 enters dichroic filter 72 formed on the face of fluorescent substrate 57 close to solid state light source unit 53 from the first direction; is transmitted through blue-transmitting dichroic filter 72; and enters the phosphor region or the diffusion region formed on the face of fluorescent substrate 57 close to first condenser lens 61. The light that has entered segments 73, 74, 76, and 77 of the phosphor region emits fluorescent color light containing green and red components and is discharged to the first direction. The fluorescent light emitted toward blue-transmitting dichroic filter 72 is reflected by dichroic filter 72 and is discharged to the first direction. Blue light that has entered segments 75 and 78 of the diffusion regions is diffused, and then is discharged to the first direction.

First condenser lens 61 condenses light discharged from fluorescent substrate 57 in a range of ±76 degrees and converts it to substantially parallel light. The traveling direction of light from first condenser lens 61 is converted from the first direction to the second direction opposite to the first by mirrors 62 and 63. Light from mirror 63 is condensed through second condenser lens 64 and is transmitted through fluorescent substrate 57 and then condensed through color filter substrate 59. The incident angle of the light that enters filter substrate 59 is ±33 degrees and its spot diameter is approximately 2 mm to 4 mm.

The green light enters segments 81 and 84 of color filter substrate 59; the red light enters segments 82 and 85 of color filter substrate 59. The green and red light that has entered color filter substrate 59, with its unnecessary color components removed, becomes green and red light with favorable color purity. Blue light that enters segments 83 and 86 of color filter substrate 59 is transmitted. In this way, white light is discharged from color filter substrate 59 to the second direction. In this embodiment, the fluorescent substrate has a diameter larger than the color filter substrate (i.e., the color filter substrate has a diameter smaller than the fluorescent substrate), thereby providing a light source apparatus compact and high in the fluorescence conversion efficiency.

Fluorescent substrate 57 may be a crystal substrate that has a heat conductivity lower than sapphire but is less expensive. Owing to an appropriate division ratio (division angle) of six segments 73, 74, 75, 76, 77, and 78 based on the value of efficiency in converting the wavelength from exciting light to each fluorescent light, the intensity ratio of green, red, and blue light can be adjusted, thereby providing white light with favorable white balance.

The fluorescent substrate may be divided into eight segments: red phosphors, green phosphors, Ce-activated YAG-based yellow phosphors, and diffusion regions. Then, the color filter substrate is divided into eight segments as well, and a color filter is formed that corresponds to yellow light fluorescence-emitted by the yellow phosphor in a region corresponding to the region where the yellow phosphor is formed. Using a yellow phosphor allows providing bright white light with more favorable white balance.

In FIG. 3, one solid state light source unit is used; multiple solid state light source units may be used that are combined by mirrors.

As described above, light source apparatus 12 of this embodiment includes a fluorescent substrate that emits fluorescent light by exciting light from a solid state light source; and an optical system, in which a color filter substrate with a diameter smaller than that of the fluorescent substrate is disposed on one motor, that leads light from the phosphor region so as to be discharged to the first direction (i.e., the direction in which the exciting light enters) and so as to enter the color filter region from the second direction that is opposite to the first direction, thereby providing a light source apparatus compact and high in the fluorescence conversion efficiency.

In the second embodiment, color filter substrate 59 is formed with a diameter smaller than that of fluorescent substrate 57. However, it is only required that the color filter of color filter substrate 59 and the part of color filter substrate 59 where the antireflection coat is formed has a diameter smaller than that of fluorescent substrate 57, and thus color filter substrate 59 itself may have an external diameter approximately the same as that of fluorescent substrate 57. In this case, fluorescent substrate 57 and color filter substrate 59 may be interchanged. This diffusion part having the function of diffusion plate 56 allows color filter substrate 59 and diffusion plate 56 to be integrally formed.

In the second embodiment, fluorescent substrate 57 is disposed close to first condenser lens 61, and color filter substrate 59 is disposed close to diffusion plate 56, where fluorescent substrate 57 and color filter substrate 59 can be interchanged.

### Third Exemplary Embodiment

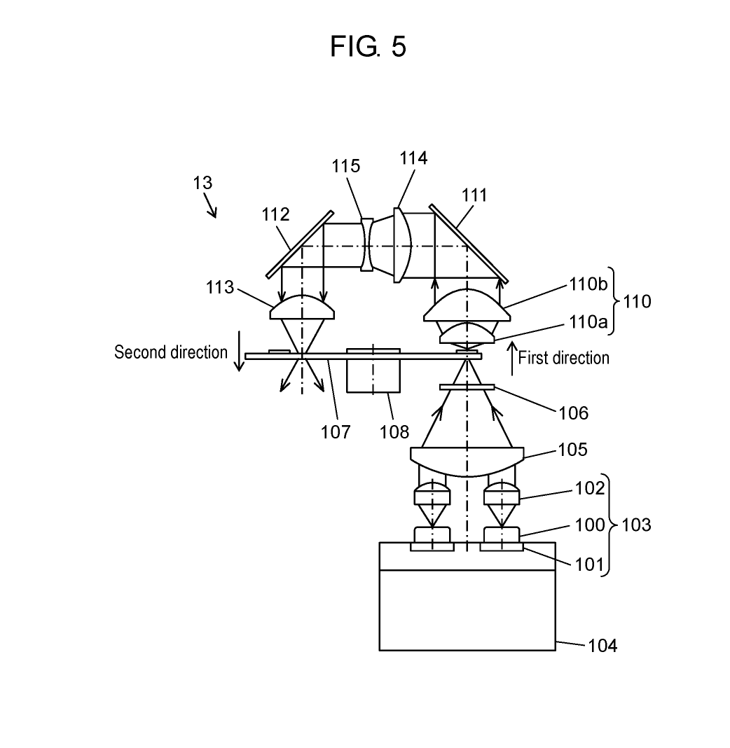

FIG. 5 is a block diagram of light source apparatus 13 illustrating the third exemplary embodiment. Light source apparatus 13 has solid state light source unit 103 that includes semiconductor laser 100 as a solid state light source, radiator plate 101, and collimate lens 102. Light source apparatus 13 further includes heat sink 104, lens 105, diffusion plate 106, substrate 107 on which a phosphor and a color filter are formed, motor 108, first condenser lens 110 composed of one set of lenses 110a and 110b, mirrors 111 and 112, and second condenser lens 113. The above configuration is the same as that of light source apparatus 11 of the first embodiment. The third embodiment is different from the first embodiment in that lenses 114 and 115 are disposed between mirrors 111 and 112. The detailed configuration of substrate 107 is the same as that of substrate 27 of light source apparatus 11, and thus its duplicate description is omitted.

Each light beam discharged from multiple semiconductor lasers 100 is condensed through corresponding collimate lens 102 and is converted into a parallel light pencil. The group of the light pencils is condensed through convex lens 105 and enters diffusion plate 106. Diffusion plate 106, made of glass, diffuses light with microscopic asperities on its surface. The diffusion angle, a half-value angle width at which the intensity of diffusion light reaches 50% of the maximum, is as small as approximately 3 degrees. Assuming that a spot diameter is defined as a diameter at which the intensity of light reaches 13.5% of the peak intensity, the light discharged from diffusion plate 106 is superimposed to spotted light with a spot diameter of 1 mm to 2 mm and enters substrate 107. Diffusion plate 106 diffuses light so that the spotted light has a desired diameter.

Substrate 107 is a circular substrate rotationally controllable with motor 108 provided in its center. A phosphor region and a diffusion region are formed on the outer circumference of substrate 107, and a color filter region and an antireflection coat region are formed on the inner circumference of substrate 107. Substrate 107 is a sapphire substrate with a high transmittance and a high heat conductivity, and at the same time rotating substrate 107 suppresses a temperature rise of the phosphor due to exciting light, thereby stably maintaining the efficiency of fluorescence conversion. FIG. 5 shows the first direction in which light from solid state light source unit 103 enters the phosphor region of substrate 107, and the second direction in which the light enters the color filter region of substrate 107. The light that has entered the phosphor region of substrate 107 emits fluorescent color light containing green and red components and is discharged to the first direction. Blue light that has entered the diffusion region of substrate 107 is diffused, and then is discharged to the first direction.

The fluorescent light and the blue light discharged to the first direction are condensed through first condenser lens 110. First condenser lens 110 condenses light discharged from substrate 107 in a range of ±76 degrees and converts it to parallel light. Light from first condenser lens 110 is reflected by mirror 111 and then becomes parallel light with its light pencil diameter reduced by lenses 114 and 115. The traveling direction of the light that has been discharged from lens 115 is converted by mirror 112 from the first direction to the second direction opposite to the first. Light from mirror 112 is condensed to the color filter region or the antireflection coat region of substrate 107 by second condenser lens 113. The incident angle of the light is ±33 degrees and its spot diameter is approximately 2 mm to 4 mm.

The green and red light that has entered the color filter region, with its unnecessary color components removed, becomes green and red light with favorable color purity. Blue light that enters the antireflection coat region is transmitted. In this way, white light is discharged from substrate 107 to the second direction.

As described above, light source apparatus 13 of this embodiment includes one substrate that has a phosphor region emitting fluorescent light by exciting light from a solid state light source and a color filter region where a color filter is formed; and an optical system that leads light from the phosphor region so as to be discharged to the first direction (i.e., the direction in which the exciting light enters) and so as to enter the color filter region from the second direction that is opposite to the first direction, and has lenses 114 and 115 for reducing the light pencil diameter. Thus, substrate 107 can be formed with a diameter smaller than that of substrate 27 of light source apparatus 11 disclosed in the first embodiment, thereby providing a light source apparatus very compact and high in the fluorescence conversion efficiency.

Note that in light source apparatus 13 of the third embodiment, substrate 107 is used that is the same as substrate 27 of light source apparatus 11 disclosed in the first embodiment, where substrate 107 can be used that is the same as substrate unit 60 of light source apparatus 12 disclosed in the second embodiment.

### Fourth Exemplary Embodiment

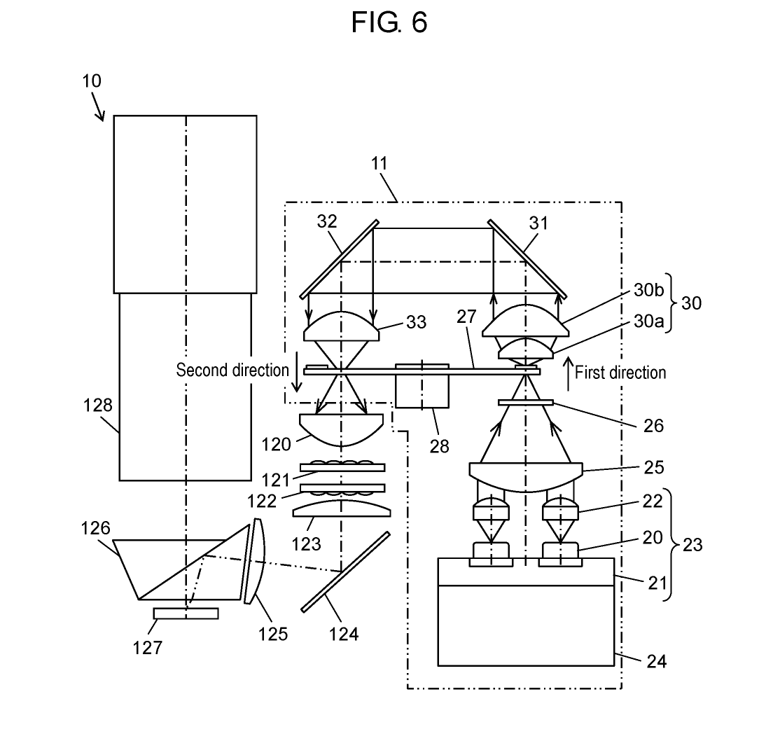

FIG. 6 illustrates projection display apparatus 10 according to the fourth exemplary embodiment of the disclosure. One DMD is used as an image-forming means.

Light source apparatus 11 includes solid state light source unit 23 composed of semiconductor laser 20 as a solid state light source, radiator plate 21, and collimate lens 22. Light source apparatus 11 further includes heat sink 24, lens 25, diffusion plate 26, substrate 27 on which a phosphor and a color filter are formed, motor 28, first condenser lens 30, mirrors 31 and 32, and second condenser lens 33. FIG. 6 shows the first direction in which light from solid state light source unit 23 enters the phosphor region of substrate 27, and the second direction in which the light enters the color filter region of substrate 27. This configuration is the same as that of light source apparatus 11 according to the first embodiment of the disclosure. In FIG. 6, a component same as that of FIGS. 1, and 2A through 2C is given the same reference number.

Light source apparatus 11 discharges red, green, and blue light chronologically due to rotation of substrate 27. The light from light source apparatus 11 is converted to parallel light by condenser lens 120, and then enters first lens array plate 121 composed of multiple lens elements. The light pencil that has entered first lens array plate 121 is divided into a large number of light pencils. The resulting light pencils converge in second lens array plate 122 composed of multiple lenses. The lens element of first lens array plate 121 has an open shape that is an analogue of DMD 127. The focal length of the lens element of second lens array plate 122 is determined so that first lens array plate 121 has a substantially conjugate relation with DMD 127. Light discharged from second lens array plate 122 enters superimposing lens 123. Superimposing lens 123 superimposes light discharged from each lens element of second lens array plate 122 for illumination.

Light from superimposing lens 123 is reflected by mirror 124, and then enters field lens 125. Field lens 125 efficiently condenses illumination light to projection lens 128. The illumination light from field lens 125 enters total reflection prism 126. Total reflection prism 126 is composed of two prisms, which have a thin air layer formed between their adjacent planes, where the air layer totally reflects light incoming at the critical angle or greater. The illumination light from field lens 125 is totally reflected to illuminate DMD 127, and at the same time projection light discharged from DMD 127 is transmitted. In this way, the components from condenser lens 120 to total reflection prism 126 compose an illumination optical system that illuminates the DMD as an illumination-target region. A mirror-deflecting DMD is an example of an image forming element.

Light entering DMD 127, with only its light pencils required for forming an image deflected, is transmitted through total reflection prism 126, and then enters projection lens 128. Projection lens 128 enlarge-projects image light modulate-formed by DMD 127. With one DMD used, and with light source apparatus 11 according to the first embodiment of the disclosure used for a light source apparatus, a compact, bright projection display apparatus with a long service life can be configured.

As an integrator optical system for achieving a required level of uniformity of a projection image, two lens array plates are used; however, a rod may be used.

As described above, a projection display apparatus of the disclosure includes one substrate that has a phosphor region emitting fluorescent light by exciting light from a solid state light source and a color filter region where a color filter is formed, both on the outer and inner circumferences; and an optical system that leads light from the phosphor region so as to be discharged to the first direction (i.e., the direction in which the exciting light enters) and so as to enter the color filter region from the second direction that is opposite to the first direction. With such a light source apparatus included, an integrator illumination optical system using a lens array and one DMD configure a compact, bright projection display apparatus with a high uniformity of a projection image.

Note that projection display apparatus 10 according to the fourth embodiment uses light source apparatus 11 disclosed in the first embodiment as a light source apparatus; however, light source apparatuses 12 and 13 disclosed in the second and third embodiments can be used as well.

### INDUSTRIAL APPLICABILITY

The disclosure is applicable to a projection display apparatus using an image-forming means.

What is claimed is:

1. A light source apparatus comprising:
a solid state light source;
a substrate including a phosphor region having a phosphor emitting fluorescent light produced by exciting light supplied from the solid state light source, and a color filter region having a color filter inside the phosphor region; and
an optical unit for leading light from the phosphor region so as to be discharged to a first direction that is a direction in which the exciting light enters, and so as to enter the color filter region from a second direction that is opposite to the first direction.

2. A light source apparatus comprising:
a solid state light source;
a fluorescent substrate emitting fluorescent light produced by exciting light supplied from the solid state light source;
a color filter substrate having a color filter; and
an optical unit for leading light from the phosphor region discharged to a first direction that is a direction in which the exciting light enters so as to enter the color filter region from a second direction that is opposite to the first direction,
wherein the fluorescent substrate and the color filter substrate are disposed alongside of each other on a same rotary drive axis, and
wherein the color filter has a diameter smaller than that of the fluorescent substrate.

3. The light source apparatus of claim 1, wherein the optical unit includes:
a first condenser lens for condensing fluorescent light emitted to the first direction and converting the light to substantially parallel light;
a mirror for converting the first direction to the second direction; and
a second condenser lens for condensing light beams of the substantially parallel light to the color filter region.

4. The light source apparatus of claim 2, wherein the optical unit includes:
a first condenser lens for condensing fluorescent light emitted to the first direction and converting the light to substantially parallel light;
a mirror for converting the first direction to the second direction; and
a second condenser lens for condensing light beams of the substantially parallel light to the color filter region.

5. The light source apparatus of claim 1, wherein the optical unit includes:
a first condenser lens for condensing fluorescent light emitted to the first direction and converting the light to substantially parallel light;
a lens for reducing a diameter of the substantially parallel light supplied from the first condenser lens;
a second condenser lens for condensing the parallel light with the diameter reduced to the color filter region; and
a mirror for converting the first direction to the second direction.

6. The light source apparatus of claim 2, wherein the optical unit includes:
a first condenser lens for condensing fluorescent light emitted to the first direction and converting the light to substantially parallel light;
a lens for reducing a diameter of the substantially parallel light supplied from the first condenser lens;
a second condenser lens for condensing the parallel light with the diameter reduced to the color filter region; and
a mirror for converting the first direction to the second direction.

7. The light source apparatus of claim 1, wherein the solid state light source is a blue semiconductor laser.

8. The light source apparatus of claim 2, wherein the solid state light source is a blue semiconductor laser.

9. The light source apparatus of claim 1, wherein the substrate having the phosphor region and the color filter region is a circular substrate rotationally controllable.

10. The light source apparatus of claim 1, wherein the substrate having the phosphor region and the color filter region is a sapphire substrate.

11. The light source apparatus of claim 1, wherein the substrate having the phosphor region and the color filter region is a crystal substrate.

12. The light source apparatus of claim 2, wherein the fluorescent substrate and the color filter substrate are circular substrates rotationally controllable.

13. The light source apparatus of claim 2, wherein the fluorescent substrate is a sapphire substrate.

14. The light source apparatus of claim 2, wherein the fluorescent substrate is a crystal substrate.

15. A projection display apparatus comprising:
the light source apparatus of claim 1;
an illumination optical system for condensing light from the light source apparatus;
an image forming element for forming an image from the light condensed through the illumination optical system according to an image signal; and
a projection lens for enlarge-projecting the image formed by the image forming element.

16. A projection display apparatus comprising:
the light source apparatus of claim 2;
an illumination optical system for condensing light from the light source apparatus;
an image forming element for forming an image from the light condensed through the illumination optical system according to an image signal; and
a projection lens for enlarge-projecting the image formed by the image forming element.

17. The projection display apparatus of claim 12, wherein the image forming element is a digital micromirror device (DMD) of mirror-deflecting type.
